(19) United States
(12) Patent Application Publication
(10) Pub. No.: US 2018/0329497 A1
(43) Pub. Date: Nov. 15, 2018

(54) INPUT DEVICE

(71) Applicant: ALPS ELECTRIC CO., LTD., Tokyo (JP)

(72) Inventors: Kazuhito Oshita, Miyagi-ken (JP); Daisuke Takai, Tokyo (JP); Hiroshi Shigetaka, Tokyo (JP); Hiroaki Takahashi, Tokyo (JP); Jo Ri, Tokyo (JP)

(21) Appl. No.: 15/970,023

(22) Filed: May 3, 2018

(30) Foreign Application Priority Data
May 12, 2017 (JP) 2017-096052

(51) Int. Cl. G06F 3/01; G06F 3/0488; G06F 3/041

(52) U.S. Cl. CPC G06F 3/016; G06F 3/0416; G06F 3/0414; G06F 3/04883

(57) ABSTRACT

An input device includes an operating surface at which touch operations relating to changing a display form of a display object are performed, a contact sensor configured to detect touch operations as to the operating surface, a pressure sensor configured to detect pressing operations as to the operating surface, a tactile feedback presentation element configured to present tactile feedback corresponding to operations detected by the touch sensor, and a tactile feedback controller configured to control the tactile feedback presented by the tactile feedback presentation element. In a case where an operation detected by the touch sensor is a specified operation specified beforehand out of the contact operations relating to changing the display form, the tactile feedback controller causes the tactile feedback presentation element to present tactile feedback corresponding to that specified operation.

### CLAIM OF PRIORITY

This application claims benefit of priority to Japanese Patent Application No. 2017-096052 filed on May 12, 2017, which is hereby incorporated by reference in its entirety.

### BACKGROUND

### 1. Field of the Disclosure

The present disclosure relates to an input device that can present tactile feedback corresponding to a touch operation performed by a user regarding changing a display form of a display object.

### 2. Description of the Related Art

Processing such as enlarging/reducing or rotating display objects are performed on a conventional input device having a touch sensor, by movement of two fingers in contact with an operating screen. That is to say, the display object is enlarged or reduced by performing pinching operations where the distance between two fingers is changed, and the display angle of the display object is changed by a rotating operation where two fingers are moved in an arc (e.g., Japanese Unexamined Patent Application Publication No. 2013-205980).

However, with the above-described conventional input device, a great load is placed on the user, since fine adjustments need to be continuously made while carefully watching the screen to achieve the desired form when changing the display form of the display screen (display object), such as enlarging, reducing, or rotating the display screen. This has also restricted other operations and actions. This problem has also been manifested when returning the display screen that has been subjected to enlargement, reduction, or rotation, to the original form. In a case where the input device is a separate entity from the display, there is a need to continue to watch the screen even more carefully, since intuitive operations are more difficult than in a case where these are integrated.

### SUMMARY

An input device includes an operating surface at which touch operations relating to changing a display form of a display object are performed, a contact sensor configured to detect touch operations as to the operating surface, a pressure sensor configured to detect pressing operations as to the operating surface, a tactile feedback presentation element configured to present tactile feedback corresponding to operations detected by the touch sensor, and a tactile feedback controller configured to control the tactile feedback presented by the tactile feedback presentation element. In a case where an operation detected by the touch sensor is a specified operation specified beforehand out of the contact operations relating to changing the display form, the tactile feedback sense controller causes the tactile feedback presentation element to present tactile feedback corresponding to that specified operation.

Accordingly, when changing of the display form of the display object is a specified operation serving as a separation, a tactile feedback is presented to the user touching the operating surface, so the user does not need to continuously watch the display object. Accordingly, the load on the user can be reduced, and the desired display form can be accurately yielded.

### BRIEF DESCRIPTION OF THE DRAWINGS

FIGS. 1A and 1B illustrate an input device according to an embodiment of the present invention, where FIG. 1A is a side view illustrating the configuration of the input device, and FIG. 1B is a plan view thereof;

FIG. 2 is a functional block diagram of the input device according to the embodiment of the present invention;

FIG. 3 is a diagram illustrating the internal structure of a vibrating element according to the embodiment of the present invention;

FIG. 4 is a plan view of an electrostatic sensor according to the embodiment of the present invention;

FIG. 5 is a partially enlarged diagram of portion V in FIG. 4, illustrating the electrode structure of the electrostatic sensor illustrated in FIG. 4;

FIG. 6 is a cross-sectional view taken along line VI-VI in FIG. 5, illustrating the layered structure of the electrostatic sensor;

FIG. 7 is an enlarged frontal view where electrode patterns of the piezoelectric sensor according to the embodiment of the present invention are illustrated enlarged;

FIG. 8 is a cross-sectional view taken along line VIII-VIII in FIG. 7, illustrating the layered structure of a piezoelectric sensor;

FIG. 9 is an enlarged plan view illustrating a state where the piezoelectric sensor is laid on the electrostatic sensor;

FIG. 10 is a circuit block diagram illustrating wiring of the piezoelectric sensor, and a drive detection circuit, according to the embodiment of the present invention;

FIGS. 11A and 11B are diagrams for describing operations of the piezoelectric sensor in the embodiment of the present invention;

FIG. 12 is a flowchart illustrating a flow of vibration request distinguishing processing relating to pinching operations for enlarging/reducing a display object in the embodiment of the present invention;

FIG. 13 is a flowchart illustrating the flow of vibration request distinguishing processing relating to rotating operations of a display object in the embodiment of the present invention;

FIG. 14 is a flowchart of vibration type selection in the embodiment of the present invention; and

FIGS. 15A and 15B illustrate an input device according to a modification of the present invention, where FIG. 15A is a side view of the input device, and FIG. 15B is a plan view thereof.

### DESCRIPTION OF THE EXEMPLARY EMBODIMENTS

An input device according to an embodiment of the present invention will be described below in detail, with reference to the drawings. This input device is used in a keyboard device for a personal computer, a touch panel used in a smartphone or tablet, and instrument panel of an automobile, and so forth. The entire input device can be configured of transparent materials, and thus be disposed overlaid upon a displays such as a color liquid crystal panel or the like (on the front side of the display). A display device may be provided separately, without being overlaid by the input device. The drawings show X-Y-Z axes as reference axes. The Z axis is in the direction in which a glass plate serving as an operating surface, a piezoelectric sensor serving as a pressure sensor, and an electrostatic sensor serving as a touch sensor, are layered. The X-Y axis is a plane orthogonal to the Z axis. In the following description, the direction of the Z axis will be referred to as “vertical direction”, and a viewing along the Z axis from the upper side will be referred to as “plan view”.

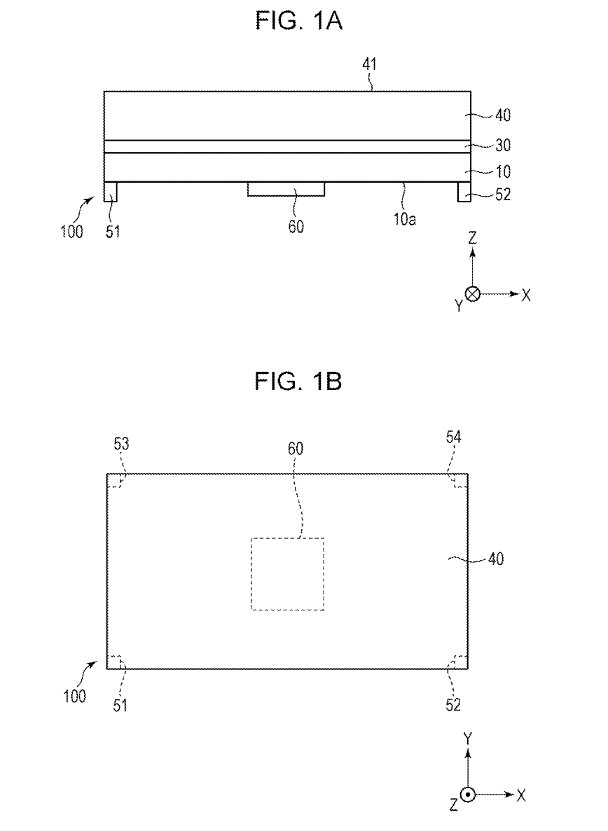

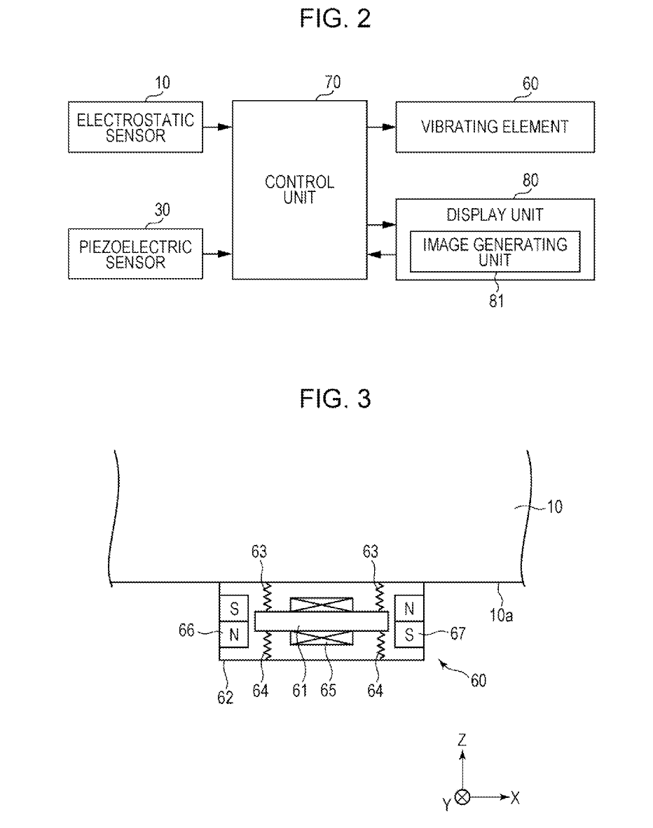

FIG. 1A is a side view illustrating the configuration of an input device 100 according to the present embodiment, and FIG. 1B is a plan view of the input device 100. FIG. 2 is a functional block diagram of the input device 100. FIG. 3 is a diagram illustrating the inner structure of a vibrating element 60. The input device 100 has a piezoelectric sensor 30 disposed upon an electrostatic sensor 10, and a glass plate 40 is further disposed upon the piezoelectric sensor 30. The electrostatic sensor 10, piezoelectric sensor 30, and glass plate 40 all have a same rectangular planar form that is long in the X direction, and are disposed so as to match in plan view.

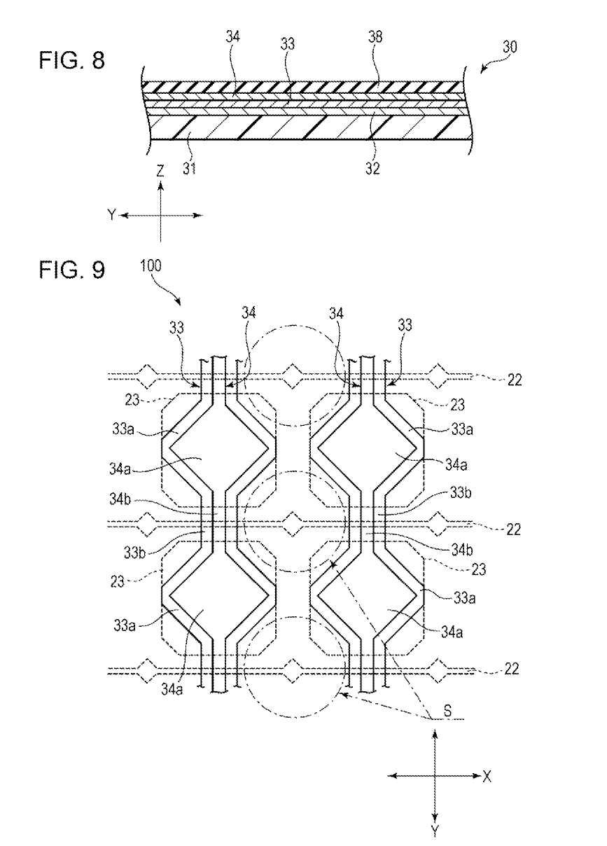

Although the piezoelectric sensor 30 is used as a pressure sensor in the present embodiment, a piezoelectric sensor having a configuration other than that illustrated in FIGS. 7 and 8 may be used, and electric resistance or electrostatic sensors may be used as long as pressure can be detected.

Suspension members 51, 52, 53, and 54 are attached to the four corners of a bottom face 10a of the electrostatic sensor 10, as illustrated in FIGS. 1A and 1B. The suspension members 51 through 54 are formed from a compression-deformable elastic material such as rubber or the like, a synthetic resin hinge that is elastically deformable, a compression coil spring, or the like. The suspension members 51 through 54 provided at the four locations all have the same shape, and have the same modulus of elasticity (spring constant). Note that suspension members 51 through 54 having different shapes or materials may be used, as long as the elasticity is the same.

The piezoelectric sensor 30 is fixed to the electrostatic sensor 10 by an adhesive agent (omitted from illustration). Performing a downward (in the down direction in FIG. 1A) pressing operation as to the glass plate 40 applies pressing force to the piezoelectric sensor 30, which is deformed by compression. The modulus of elasticity (spring constant) at the time of the piezoelectric sensor 30 deforming is appropriately set with regard to the modulus of elasticity (spring constant) when the suspension members 51 through 54 are contraction-deformed in the Z direction, so that desired output is obtained from the piezoelectric sensor 30.

A vibrating element 60 serving as a tactile feedback presenting element is provided at the middle of the bottom face 10a of the electrostatic sensor 10. The vibrating element 60 has a configuration where a vibrator 61 is supported by springs 63 and 64 within a metal case (cover) 62 so as to be capable of vibrating, as illustrated in FIG. 3. A coil 65 is wound around the vibrator 61, and magnets 66 and 67 are fixed within the case facing the coil. The magnet 66 and magnet 67 have magnetized faces facing the edge of the vibrator 61, with the magnetized faces having been magnetized so as to have different magnetic poles in the vibration direction of the vibrator 61. The faces of the magnet 66 and magnet 67 that face each other are of the opposite polarity to each other. AC current serving as a control signal is applied from a controller 70 serving as a tactile feedback controller to the coil 65, thereby vibrating the vibrator 61, and the vibrating element 60 presents later-described predetermined vibration information. That is to say, the vibrating element 60 presents predetermined vibration information as tactile feedback, under control of the controller 70 (FIG. 2). Note that the vibrating element 60 may be an arrangement where the vibrator is formed of a magnet, and a coil facing the vibrator is fixed within the case. A configuration may also be made where the vibrating element 60 is formed of a piezoelectric element, and vibrates in accordance with control signals from the controller 70. The controller 70 may include a touchpad control microprocessor or a PC-BIOS for the Windows operating system (OS).

The vibrating element 60 operates in accordance with vibration request signals provided by the controller 70, and presents vibrations with varying intensity of vibration, vibration time, cycles and so forth. The controller 70 detects operations performed as to the glass plate 40, based on output signals from the electrostatic sensor 10. Operations detected by the controller 70 include operations regarding change in the display state of a display object on the display 80, e.g., enlarging, reducing, and rotating. The controller 70 detects whether such operations include operations specified beforehand and stored in a storage unit within the controller 70 (hereinafter may be referred to as “specified operation”). With regard to such specified operations, enlargement/reduction of the display object may include

(1) a specified display scale, and

(2) a specified scale (proportion) as to the current display size. Examples of such scale include integer multiples, integer inverses, and percentage values in increments of 10%. Rotation of the display object may include

(1) a specified angle as to a reference axis, and

(2) a rotation angle as to the current display angle. Examples of such angle include angle values in 15-degrees increments. The controller 70 distinguishes whether or not an operation that has been detected is a specified operations, and if a specified operation, causes the vibrating element 60 to present predetermined vibration information as tactile feedback as to the specified operation. The presented information may be in common for all specified operations, or may have different intensity of vibration, cycle, and so forth, for each specific value of enlargement/reduction scale or rotation angle.

The controller 70 distinguishes whether or not the display object has returned to a reference display form, and in a case of having distinguishes that the display object has returned to the reference display form, acts as a tactile feedback controller and causes the vibrating element 60 to present predetermined vibration information. This predetermined vibration information may be vibration information that differs from the vibration information corresponding to the specified operation. The reference display form may be either that set by the controller 70 or set by the user, and for example is an original display form in the state before having performed the specified operation.

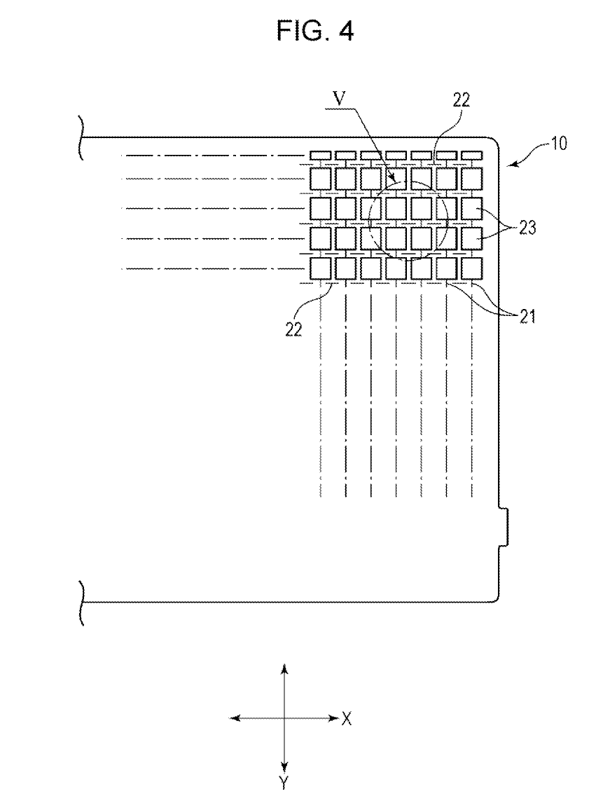

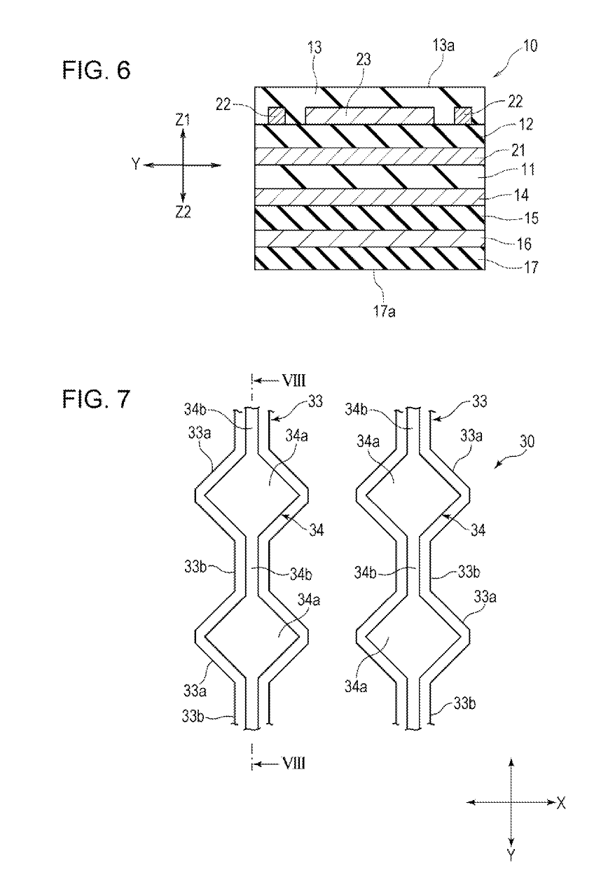

The structure of the electrostatic sensor 10 will be described with reference to FIGS. 4 through 6. The electrostatic sensor 10 is configured as a multi-layered rigid board such as illustrated in FIG. 6, having a predetermined rigidity. The electrostatic sensor 10 has an insulating base member 11 of polycarbonate or the like, with driving electrodes 21 that are electrostatic electrodes formed on the surface of the insulating base member 11 facing upwards (toward the upper side in the Z-axis direction). Above the driving electrodes 21 is covered by an inter-electrode insulating layer 12, and sensing electrodes 22 that are also electrostatic electrodes are formed on the surface of the inter-electrode insulating layer 12 facing upwards. An electroconductive layer 23 is formed on the surface of the inter-electrode insulating layer 12 facing upwards, between adjacent sensing electrodes 22. The sensing electrodes 22 and electroconductive layer 23 are covered by an upper insulating layer 13.

A shield electrode layer 14 that is set to grounding potential is provided on the entire face of the lower surface of the insulating base member 11 (lower side in the Z-axial direction), as illustrated in FIG. 6. A first lower insulating layer 15 is formed on the lower surface of the shield electrode layer 14, and a wiring layer 16 is formed on the lower surface of the first lower insulating layer 15. The wiring layer 16 is covered from below by a second lower insulating layer 17.

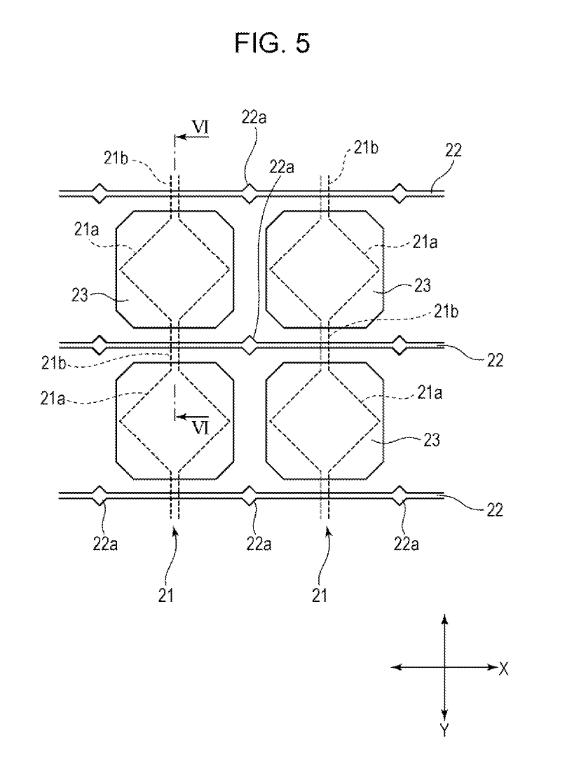

FIGS. 4 and 5 illustrate a planar pattern of the driving electrodes 21 and sensing electrodes 22 that are electrostatic electrodes, and the electroconductive layer 23. These electrostatic electrodes are formed by etching copper foil, or formed by a printing process using silver paste.

Each of the multiple driving electrodes 21 are formed extending in the Y direction, with predetermined spacing therebetween in the X direction. The driving electrodes 21 are formed with square (rhombic form) main electrode portions 21a and linking portions 21b continuing alternatingly, as an integrated form, as illustrated in FIG. 5. The main electrode portions 21a have a greater width dimension in the X direction than the linking portions 21b.

The sensing electrodes 22 are formed continuing in the X direction with predetermined spacing therebetween in the Y direction. Each of the sensing electrodes 22, and the linking portions 21b of the driving electrodes 21, intersect with the inter-electrode insulating layer 12 interposed therebetween. Sensing effect portions 22a that are slightly larger in the width dimension are provided between intersections between the sensing electrodes 22 and the driving electrodes 21.

The electroconductive layer 23 is formed on the same level as the sensing electrodes 22, on the surface of the inter-electrode insulating layer 12 facing upwards. The electroconductive layer 23 is connected neither to the sensing electrodes 22, nor to the driving electrodes 21 situated on the level below. Accordingly, the upward-facing surface of the electroconductive layer 23 is situated on the same imaginary plane parallel to the X-Y plane as the upward-facing surface of the sensing electrode 22.

The upward-facing surfaces of the sensing electrodes 22 and the electroconductive layer 23 situated therebetween is the same face, which makes it easier to smoothen an upward-facing surface 13a of the upper insulating layer 13 that covers the sensing electrodes 22 and electroconductive layer 23. Accordingly, the strength of adhesion when applying a sheet-like piezoelectric sensor 30 onto the smooth surface 13a can be made to be great. Accordingly, even if shearing force is generated in the piezoelectric sensor 30 by applying downward pressing force to the glass plate 40, the fixed state of the piezoelectric sensor 30 and electrostatic sensor 10 can be maintained. Also, the electroconductive layer 23 is formed into blocks, which are square, while the main electrode portions 21a of the driving electrodes 21 are rhombic, but the main electrode portions 21a and the blocks of the electroconductive layer 23 in the X direction and Y direction generally match in width. When driving power is applied to the driving electrodes 21, the main electrode portions 21a of the driving electrodes 21 are coupled with the electroconductive layer 23 situated thereabove through electrostatic capacitance.

The shield electrode layer 14 illustrated in FIG. 6 is formed such that the entire region of the downward-facing face (lower side in the Z-axial direction) of the insulating base member 11 is covered with copper foil, silver paste, or the like. The wiring layer 16 includes wiring conducting with the driving electrodes 21 and sensing electrodes 22, and is made up of multiple wiring lines. An integrated circuit (IC) or the like having a driving circuit built in is mounted to a downward-facing surface 17a of the second lower insulating layer 17, and the wiring lines are each connected to connection portions of the IC or the like.

Next, the structure of the piezoelectric sensor 30 will be described with reference to FIGS. 7 and 8. The piezoelectric sensor 30 is sheet-like as illustrated in FIG. 8, with a first electrode 32, piezoelectric layer 33, and second electrode 34 layer in order in the vertical direction, on the upward-facing surface of a film base member 31 formed of a synthetic resin material such as polyethylene terephthalate (PET). The first electrode 32 is a carbon electrode formed by screen printing. The piezoelectric layer 33 is formed thereupon by screen printing using piezoelectric paste, and further, the second electrode 34 is formed thereupon by screen printing. Moreover, the second electrode 34 is coated by an insulating coat 38.

Examples of piezoelectric paste include perovskite ferroelectric powder such as potassium niobate, sodium potassium, niobate barium titanate, or the like, being mixed in a thermoplastic polyester urethane resin to form a paste.

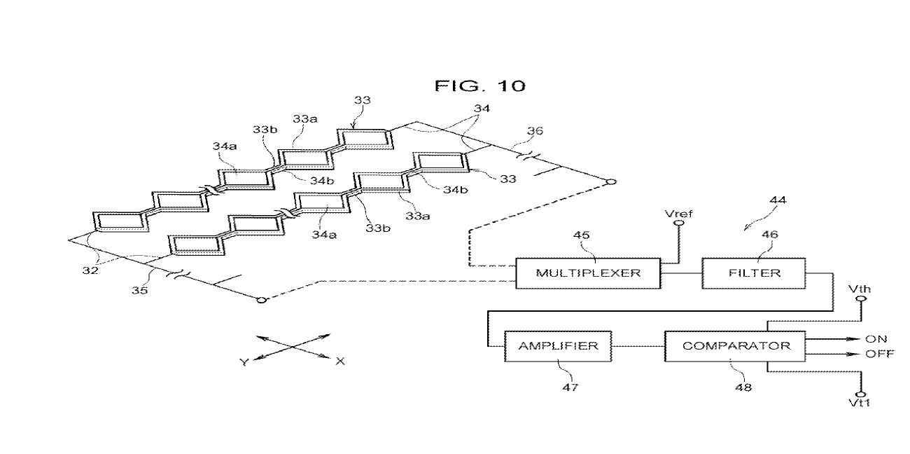

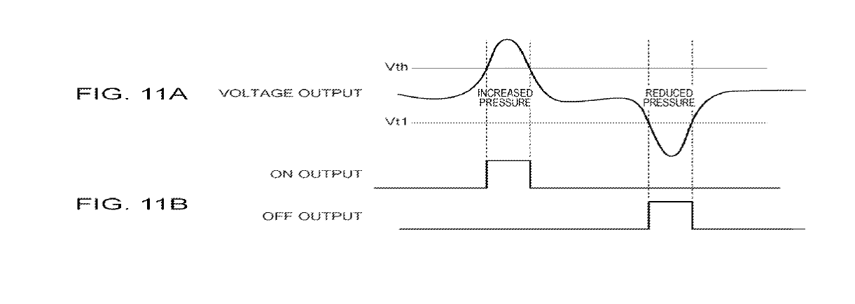

It can be seen from FIGS. 7 and 10 that multiple first electrodes 32 extend continuously in the Y direction, with intervals therebetween in the X direction. The piezoelectric layer 33 is formed with wide portions 33a and narrow portions 33b alternating in the Y direction. The second electrodes 34 are overlaid on the entire piezoelectric layer 33, and extend continuously in the Y direction along with the piezoelectric layer 33. Wide portions 34a and narrow portions 34b are also formed in the second electrodes 34, alternating in the Y direction. The first electrodes 32 and the second electrodes 34 have the same dimensions, and are overlaid so as to match in the vertical direction (Z direction).

A first electrode wiring layer 35 that connects to all first electrodes 32, and a second electrode wiring layer 36 that connects to all second electrodes 34, are provided on the inner side of an edge portion of the film base member 31 of the piezoelectric sensor 30 that extends in the X direction, as illustrated in FIG. 10. The first electrode wiring layer 35 and second electrode wiring layer 36 are led out from the piezoelectric sensor 30 and connected to the wiring layer 16 illustrated in FIG. 6, or connected to the CI or the like mounted to the lower-side surface of the electrostatic sensor 10. The first electrode wiring layer 35 and second electrode wiring layer 36 are connected to a driving detection circuit 44 built into the IC or the like.

The first electrode wiring layer 35 and second electrode wiring layer 36 are connected to a multiplexer 45 at the driving detection circuit 44, as illustrated in FIG. 10. One of the first electrode wiring layer 35 and second electrode wiring layer 36 is connected to reference voltage Vref by the multiplexer 45, and the other to a filter 46. The detection output from the multiplexer 45 passes through filter 46, is amplified at an amplifier 47, and applied to a comparator 48.

As illustrated in FIG. 1A, the input device 100 has the piezoelectric sensor 30 of the layered structure illustrated in FIG. 8 layered by adhesion on the upper face of the electrostatic sensor 10, i.e., on the upward-facing surface 13a of the upper insulating layer 13 illustrated in FIG. 6. The piezoelectric sensor 30 may be applied with the film base member 31 facing the surface 13a at this time, or with the insulating coat 38 covering the second electrodes 34 facing the surface 13a.

FIG. 9 illustrates a state of overlaying of the electrodes in the region where the piezoelectric sensor 30 is overlaid on the electrostatic sensor 10, as viewed from above. The first electrodes 32, piezoelectric layer 33, and second electrodes 34, of the piezoelectric sensor 30 are disposed laid above and following one of the driving electrodes 21 and sensing electrodes 22, out of the electrostatic electrodes of the electrostatic sensor 10. All of the first electrodes 32, the piezoelectric layer 33, and the second electrodes 34, are disposed overlaid along all driving electrodes 21 in the present embodiment.

Note that the first electrodes 32 and second electrodes 34 of the piezoelectric sensor 30 are of the same shape and same dimensions, and completely overlaid in the vertical direction. The first electrodes 32 and the wide portions 34a of the second electrode 34 are overlaid further above the main electrode portions 21a of the driving electrode 21 and the electroconductive layer 23 situated thereabove.

Next, the operations of the input device 100 will be described. First, the detection operations at the electrostatic sensor 10 and piezoelectric sensor 30 will be described.

The driving detection circuit 44 illustrated in FIG. 10 is constantly operating in the input device 100, with reference voltage Vref being applied to one of the first electrodes 32 and second electrodes 34, and the potential change of the other passing through the filter 46, being amplified at the amplifier 47, and applied to the comparator 48.

FIG. 11A illustrates change in voltage between the first electrodes 32 and second electrodes 34 when any position on the surface of the glass plate 40 is pressed by a finger or the like from above (increased pressure) and when the finger is away (reduced pressure), as voltage output. The voltage output illustrated in FIG. 11A changes in accordance with change in flexure acceleration of the piezoelectric sensor 30. The voltage change obtained by positive acceleration is subjected to waveform shaping and given as ON output at the comparator 48, while voltage change obtained by negative acceleration is subjected to waveform shaping and given as OFF output, as illustrated in FIG. 11B.

When ON output illustrated in FIG. 11B is obtained, the controller 70 detects that the input device 100 has been pressed by a finger or the like, and when OFF output is obtained, that the finger or the like has left the input device 100.

As illustrated in FIG. 9, the first electrodes 32 and the wide portions 34a of the second electrode 34, of the piezoelectric sensor 30, are formed having a relatively wide area on the surface of the electroconductive layer 23, so the area ratio of the first electrode 32 and second electrode 34 of 20% or more as to the entire area of the operating face can be secured, and preferably 30% or more. Accordingly, the detection sensitivity of the piezoelectric sensor 30 can be raised.

The sides of the first electrodes 32 and wide portions 34a of the second electrodes 34 form rhombic shapes that are angled as to the X-Y direction, while the sides of the blocks of the electroconductive layer 23 form squares extending in the X-Y direction, as illustrated in FIG. 9. Accordingly, when viewed from above, the four corners of the blocks of the electroconductive layer 23 protrude from the first electrodes 32 and wide portions 34a of the second electrodes 34. The sensing electrodes 22 pass between adjacent electroconductive layer 23 blocks and extend in the X direction.

Regions on the electrostatic sensor 10 where the first electrodes 32 of the piezoelectric sensor 30 and wide portions 34a of the second electrodes 34 do not exist are primary electrostatic detection regions S, as illustrated in FIG. 9. These electrostatic detection regions S are regions surrounded by multiple wide portions 34a, with four portions at the periphery thereof being surrounded by the corner portions of the electroconductive layer 23 blocks that are exposed from the wide portions 34a, with sensing electrodes 22 passing through the middle portions thereof.

Driving voltage is applied to the multiple driving electrodes 21 in order in the electrostatic sensor 10, but the main electrode portions 21a of the driving electrodes 21 are coupled with the electroconductive layer 23 in a floating state via electrostatic capacitance, so an electric field is formed above the glass plate 40 of the input device 100, from the electroconductive layer 23 to the sensing electrodes 22, at the electrostatic detection regions S. Accordingly, the coordinate position where a finger has touched the surface of the glass plate 40 can be detected with relatively high sensitivity, by monitoring change in current values flowing through the sensing electrodes 22 in order.

Overlaying the first electrodes 32 and second electrodes 34 of the piezoelectric sensor 30 so as to following the driving electrodes 21 of the electrostatic sensor 10, and overlaying the first electrodes 32 and the wide portions 34a of the second electrodes 34 above the wide main electrode portions 21a of the driving electrode 21 and the electroconductive layer 23 enables the footprint of the first electrodes 32 and second electrodes 34 to be maximized, and the detection sensitivity of the piezoelectric sensor 30 can be increased, as illustrated in FIG. 9. Moreover, the main electrode portions 21a or the electroconductive layer 23 coupled therewith are made to extend out from the first electrodes 32 and second electrodes 34, thereby enabling regions where the first electrodes 32 and second electrodes 34 are not present to be set to electrostatic detection regions S where detection sensitivity is high.

Note that the touch sensor and pressure sensor are not restricted to the above configurations. For example, the pressure sensor is not restricted to a piezoelectric sensor, and other types of pressure sensors, such as electric resistance or electrostatic capacitance sensors may be used. The pressure sensor may be disposed on the lower side of the board of the touch sensor, or may be disposed at the four corners of the board of the touch sensor.

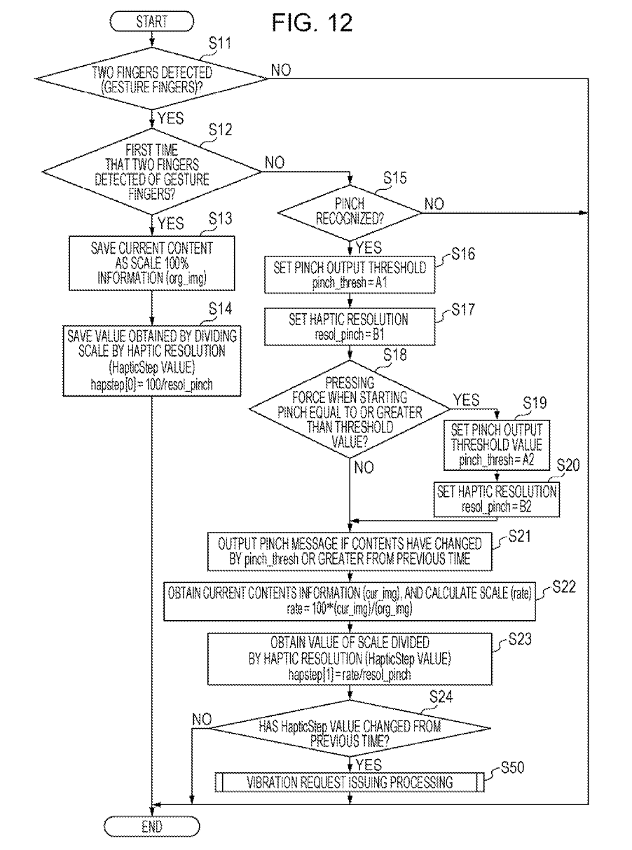

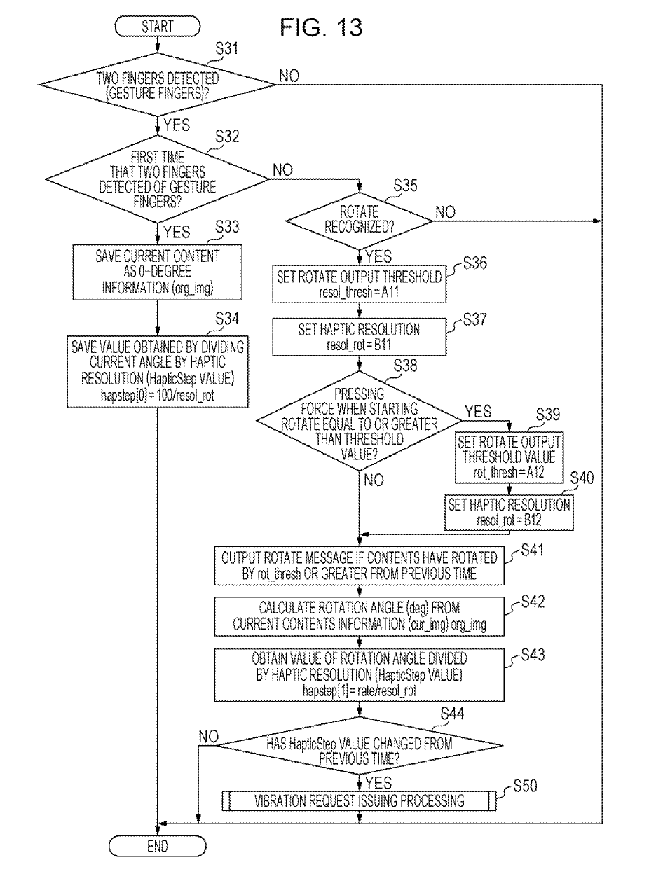

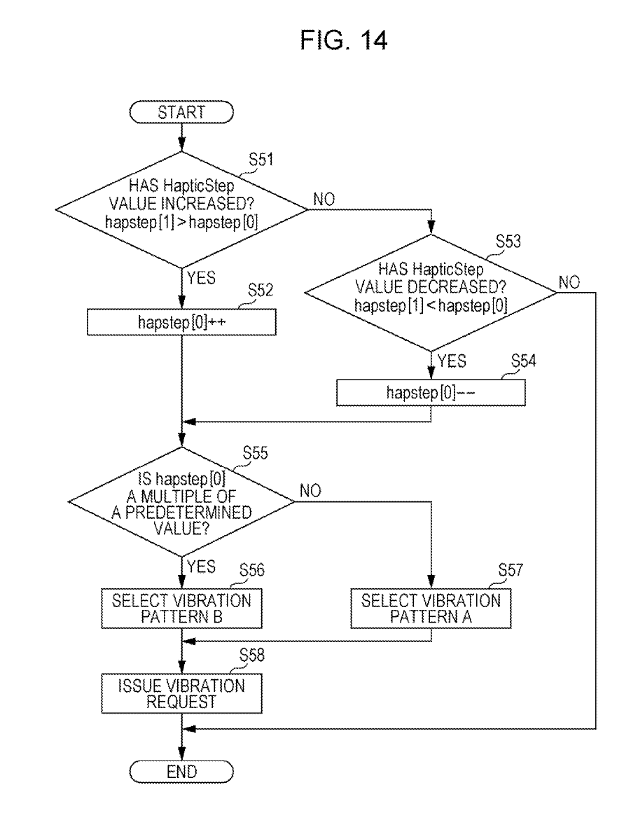

Next, presentation of tactile feedback will be described with reference to flowcharts illustrating the flow of vibration processing in FIGS. 12 through 14. FIG. 12 is a flowchart illustrating the flow of vibration request distinguishing processing relating to a pinch operation for enlargement/reduction of a display object, FIG. 13 is a flowchart illustrating the flow of vibration request distinguishing processing relating to a rotate operation for rotation of a display object, and FIG. 14 is a flowchart for vibration type selection. Although FIGS. 12 through 14 will be described regarding a case of performing enlargement/reduction or rotation operations of a display object by two-finger operations on the glass plate 40, the present invention is applicable to change of a display object by operations other than these as well.

### Pinch Operation Processing (FIG. 12)

In the processing illustrated in FIG. 12, first, the controller 70 detects whether an operation by two fingers on the glass plate 40 (gesture operation) has been performed (step S11). If not detected (NO in step S11), the flow either stands by until detected, or ends. On the other hand, in a case where an operation by two fingers is detected (YES in step S11), whether or not this is the first time that detection has been made regarding the display object currently displayed is distinguished (step S12). This distinguishing is made by whether or not “scale 100% information” or a TactileStep value is saved in a storage unit (omitted from illustration) of the controller 70. In a case where the “scale 100% information” and “0-degree information” in step S33 in FIG. 13 are in common, the above distinguishing can be made by whether or not “0-degree information” is saved in the storage unit.

In a case of having distinguishing that this is the first detection in step S12 (Yes in step S12), information of the display object currently displayed, i.e., information of current contents is obtained, and stored in the storage unit of the controller 70 as “scale 100% information” (step S13). The content information is obtained by the controller 70 from an image generating unit 81 that generates display objects on a display 80, and includes at least the overall size of the object, and coordinate information of multiple specification points that have been optionally set in the object. Further, the controller 70 calculates a value obtained by dividing the scale of the display object by tactile resolution (TactileStep value, hapstep[0]), and stores this in the storage unit (step S14). Tactile resolution is a resolution for detecting a specified operation, and corresponds to the smallest value of the percentage of enlargement/reduction to serve as sectionings of tactile feedback presentation. For example, in a case of sectioning in 10% intervals, such as 10%, 20%, . . . , 80%, 90%, 100%, 110%, 120%, and so forth, the tactile resolution is set to 10. Accordingly, in a case where the current scale of the display object is the scale to use for sectioning, the TactileStep value is an integer, and otherwise is a decimal number. The tactile resolution is a fixed value that has been set beforehand and saved in the storage unit, but can be changed by the user. For example, the user can change this from a user interface of a driver or application.

On the other hand, in a case where it has been distinguished in the step S12 that this is not the first time for detection (NO in step S12), the controller 70 distinguishes whether the operation is a pinch operation or not, based on output signals from the electrostatic sensor 10 (step S15). If not a pinch operation, the processing ends (NO in step S15).

In a case of having distinguished that this is a pinch operation in step S15 (YES in step S15), a threshold value for message output for pinch operation (pinch thresh) is set to A1 (step S16), and further, tactile resolution (resol pinch) is set to B1 (step S17).

Next, the controller 70 makes judgement regarding whether or not the pressing force by the operation when starting the pinch operation is a threshold value (predetermined value) or higher (step S18). In a case where the pressing force is the threshold value or higher (YES in step S18), the threshold value for message output for pinch operation (pinch thresh) is changed to A2 (step S19), and further the tactile resolution (resol pinch) is changed to B2 (step S20).

Now, the threshold value A2 set in step S19 preferably is a different value from the threshold value A1 set in step S16, but may be the same value as the threshold value A1. Also, the resolution B2 set in step S20 preferably is a different value from the resolution B1 set in step S17, but may be the same value as the resolution B1. In a case where the threshold value A2 is made to be the same value as the threshold value A1, and the resolution B2 is made to be the same value as the resolution B1, the aforementioned steps S18, S19, and S20 may be omitted. Also, the threshold value A2 and resolution B2 may be set to any of multiple values set in stages beforehand, in accordance with the magnitude of the pressing force when starting the pinch operation. Accordingly, the threshold value and resolution can be easily changed by intuitive operations by the user.

In a case where the pressing force is below the threshold value in step S18, after the step S19 and S20 have been executed (NO in step S18), a predetermined pinch message is output in a case where the state of the display contents has changed from the state of the previous time by the threshold value “pinch thresh” (step S21). The change judged here is change in the size of the display contents.

Next, the controller 70 obtains information of the display object currently displayed, i.e., information of current contents, calculates the scale of enlargement or reduction as to the “scale 100% information” obtained at the first detection, based on change in the coordinates of the multiple feature points and so forth, and saves in the storage unit (step S22). Next, the value (TactileStep value, hapstep[1]) obtained by dividing the scale calculated in step S22 by the tactile resolution is calculated, and saved in the storage unit (step S23).

Next, the controller 70 distinguishes whether the TactileStep value (hapstep[1]) calculated in step S23 has changed from the TactileStep value (hapstep[0]) calculated the previous time (step S24). In a case where there has been change in the TactileStep value in step S24, the vibration request issuing processing (step S50) illustrated in FIG. 14 is executed, and if there has been no change, the flow ends. Note that comparison of TactileStep values preferably is performed just by the integer portion. Thus, feedback can be kept from being repeated regarding minute change in the display object.

Now, at the third and subsequent times of pinch operation processing, the scale calculated in step S22, and the TactileStep value (hapstep[1]) calculated in step S23 are updated to the newest calculated values.

### Rotation Operation Processing (FIG. 13)

In the processing illustrated in FIG. 13, first, the controller 70 detects whether an operation by two fingers on the glass plate 40 has been performed (step S31). If not detected (NO in step S31), the flow either stands by until detected, or ends. On the other hand, in a case where an operation by two fingers is detected (YES in step S31), whether or not this is the first time that detection has been made regarding the display object currently displayed is distinguished (step S32). This distinguishing is made by whether or not “0-degree information” or a TactileStep value is saved in a storage unit of the controller 70. In a case where the “0-degree information” and “scale 100% information” in step S13 in FIG. 12 are in common, the above distinguishing can be made by whether or not “scale 100% information” is saved in the storage unit.

In a case of having distinguishing that this is the first detection in step S32 (Yes in step S32), information of the display object currently displayed, i.e., information of current contents is obtained, and stored in the storage unit of the controller 70 as “0-degree information” (step S33). The controller 70 further calculates a value obtained by dividing the current angle of the display object by tactile resolution (TactileStep value, hapstep[0]), and stores this in the storage unit (step S34). This TactileStep value is saved separately for those regarding pinch operations and those regarding rotation operations. Tactile resolution used here corresponds to the smallest value of the rotation angle serving as sectionings of tactile feedback presentation. For example, in a case of sectioning in 15-degree intervals, such as −30 degrees, −15 degrees, 0 degrees, 15 degrees, 30 degrees, and so forth, the tactile resolution is set to 15. Accordingly, in a case where the current angle of the display object is the rotation angle to use for sectioning, the TactileStep value is an integer, and otherwise is a decimal number. The tactile resolution is a fixed value that has been set beforehand and saved in the storage unit, but can be changed by the user. For example, the user can change this from a user interface of a driver or application.

On the other hand, in a case where it has been distinguished in the step S32 that this is not the first time for detection (NO in step S32), the controller 70 distinguishes whether the operation is a rotation operation or not, based on output signals from the electrostatic sensor 10 (step S35). If not a rotation operation, the processing ends (NO in step S35).

In a case of having distinguished that this is a rotation operation in step S35 (YES in step S35), a threshold value for message output for rotation operation (rot thresh) is set to A11 (step S36), and further, tactile resolution (resol rot) is set to B11 (step S37).

Next, judgement is made regarding whether or not the pressing force by the operation when starting the rotation operation is a threshold value (predetermined value) or higher (step S38). In a case where the pressing force is the threshold value or higher (YES in step S38), the threshold value for message output for rotation operation (rot thresh) is changed to A12 (step S39), and further the tactile resolution (resol rot) is changed to B12 (step S40).

Now, the threshold value A12 set in step S39 preferably is a different value from the threshold value A11 set in step S36, but may be the same value as the threshold value A11. Also, the resolution B12 set in step S40 preferably is a different value from the resolution B11 set in step S37, but may be the same value as the resolution B11. In a case where the threshold value A12 is made to be the same value as the threshold value A11, and the resolution B12 is made to be the same value as the resolution B11, the aforementioned steps S38, S39, and S40 may be omitted. Also, the threshold value A12 and resolution B12 may be set to any of multiple values set in stages beforehand, in accordance with the magnitude of the pressing force when starting the rotation operation. Accordingly, the threshold value and resolution can be easily changed by intuitive operations by the user.

In a case where the pressing force is below the threshold value in step S38, after the step S39 and S40 have been executed (NO in step S38), a predetermined rotate message is output in a case where the state of the display contents has changed from the state of the previous time by the threshold value “rot thresh” (step S41). The change judged here is change in the rotation angle of the display contents.

Next, the controller 70 obtains information of the display object currently displayed, i.e., information of current contents, calculates the rotation angle as to the “0-degree information” obtained at the first detection, based on change in the coordinates of the multiple feature points and so forth, and saves in the storage unit (step S42). Next, the value (TactileStep value, hapstep[1]) obtained by dividing the rotation angle calculated in step S42 by the tactile resolution is calculated, and saved in the storage unit (step S43).

Next, the controller 70 distinguishes whether the TactileStep value (hapstep[1]) calculated in step S43 has changed from the TactileStep value (hapstep[0]) calculated the previous time (step S44). In a case where there has been change in the TactileStep value in step S44, the vibration request issuing processing (step S50) illustrated in FIG. 14 is executed, and if there has been no change, the flow ends. Note that comparison of TactileStep values preferably is performed just by the integer portion. Thus, feedback can be kept from being repeated regarding minute change in the display object.

Now, at the third and subsequent times of rotation operation processing, the rotation angle calculated in step S42, and the TactileStep value (hapstep[1]) calculated in step S43 are updated to the newest calculated values. Vibration Request Issuing Processing (FIG. 14)

The controller 70 distinguishes, with regard to the TactileStep value obtained by the pinch operation processing illustrated in FIG. 12 or the rotation operation processing illustrated in FIG. 13, whether or not the newest value after the second or subsequent time (hapstep[1]) (step S23 in FIG. 12, step S43 in FIG. 13) has increased as compared to the initial value (hapstep[0]) (step S14 in FIG. 12, step S34 in FIG. 13) (step S51).

In a case where the TactileStep value has increased, i.e., hapstep[1]>hapstep[0] (YES in step S51), hapstep[0] is incremented by 1 (step S52). On the other hand, in a case where the TactileStep value has not increased (NO in step S51), whether or not the TactileStep value has decreased is distinguished (step S53). In a case where the TactileStep value has decreased (YES in step S53), hapstep[0] is decremented by 1 (step S54). In a case where the TactileStep value has not decreased (NO in step S53), this means that there has been no change in the TactileStep value, i.e., that neither size change nor rotation has been performed regarding the display object, so the processing ends.

Next, the controller 70 distinguishes whether the hapstep[0] incremented in step S52 or decremented in step S54 is a multiple of a predetermined value (step S55). Accordingly, how much the enlargement/reduction or rotation has been performed as to the original contents (step S13 in FIG. 12, step S33 in FIG. 13) can be distinguished. In a case of a multiple (YES in step S55), a vibration pattern B is selected (step S56), while in a case of not being a multiple (NO in step S55), a vibration pattern A that differs from vibration pattern B is selected (step S57). The controller 70 issues a vibration request in accordance with the vibration pattern selected in steps S56 or 57, and the vibrating element 60 presents vibration information accordingly.

Now, an arrangement may be made regarding selection of vibration pattern A and vibration pattern B (Step S55 through S57), where vibration pattern B is selected (step S56) in a case where conditions of angle or scale indicated by a driver or application have been satisfied (YES in step S55), and vibration pattern A that differs from vibration pattern B is selected (step S57) in a case where the conditions are not satisfied (NO in step S55).

Due to being configured as described above, tactile feedback is presented to the user touching a pad face (operating face) of the glass plate 40 serving as an operating surface in the present embodiment when a specified operation is made so that change in the display form of a display object is for a sectioning, more specifically when a touch operation is performed for a display scale or rotation angle which, when divided by tactile resolution, yields an integer value. Accordingly, the user does not have to continuously watch the display object when changing the display form of the display object, so the load on the user is reduced, reduction in work efficiency can be prevented, and a desired display form can be accurately yielded.

A modification will be described below. An arrangement is preferably made where, after change in the display form is performed, the display form before the change in display form was performed is returned to, and further, when the display object returns to the original display form, tactile feedback corresponding thereto is presented by the vibrating element 60 serving as the tactile feedback presenting element. Accordingly, the user can easily recognize that the display object has returned to the original state.

The controller 70 and display 80 may both be included in the input device 100 illustrated in FIG. 1, or one or both being included in a separate external device (e.g., computer system). Tactile resolution may be settable to an optional value at an optional timing.

Vibration information presented by the vibrating element 60 may be the same vibration information presented for each sectioning scale or angle, or different vibration information may be presented for each scale or angle. The intensity direction, or cycle, for example, of vibration, may be changed as vibration information. Further, in addition to the vibration information, sound may be emitted, an object may be additionally displayed, warm or cool sensation may be presented, or the like, to facilitate user recognition of change in the display form.

An arrangement where vibration information is presented when the piezoelectric sensor 30 serving as a pressure sensor detects pressure as well, enables the user to perform touch operations detected by the electrostatic sensor 10 and pressing operations detected by the piezoelectric sensor 30, appropriately distinguished.

Also, an arrangement may be made where, in a case that the user performing a pinch operation on the pad face 41 does not involve a pressing operation, the display may be consecutively enlarged/reduced without presenting vibrations, and in a case where a pinch operation is made in a state where the pad face 41 is pressed down upon, vibration is presented each time the enlargement/reduction reaches a predetermined scale increment.

Also, an arrangement may be made where, in a case that the user performing a rotation operation on the pad face 41 does not involve a pressing operation, the display may be consecutively rotated without presenting vibrations, and in a case where a rotation operation is made in a state where the pad face 41 is pressed down upon, vibration is presented each time the rotation reaches a predetermined angle increment.

In a case where the pressure detected by the piezoelectric sensor 30 when a pinch operation is performed is at the threshold value or higher, the frequency of presenting the tactile feedback may be changed in accordance with that pressure. Thus, the user can be presented with the magnitude of the pressing force when operating, accurately and intuitively.

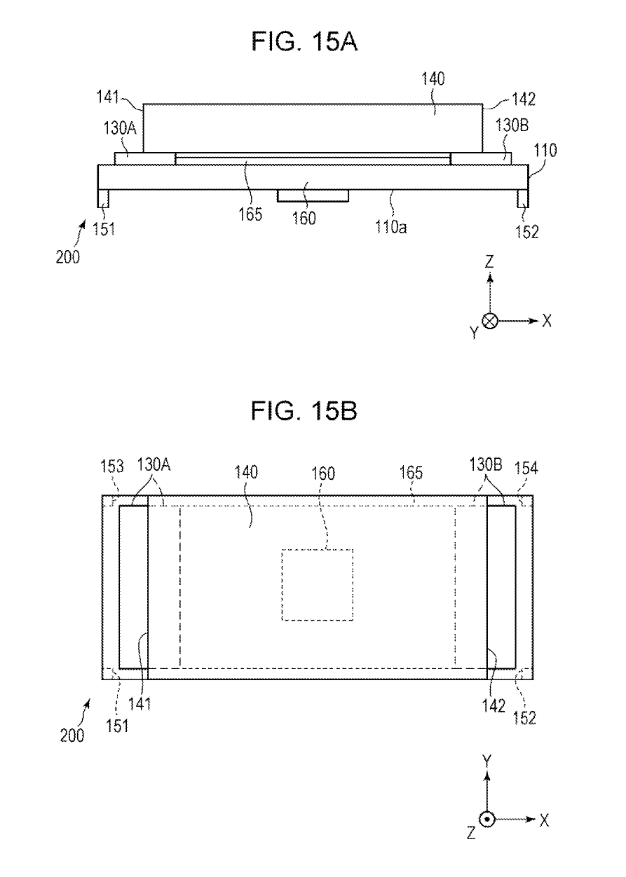

FIG. 15A is a side view of an input device 200 according to a modification of the above-described embodiment, and FIG. 15B is a plan view of the input device 200. In the input device 200 illustrated in FIGS. 15A and 15B, two voltage sensors 130A and 130B, and a spacer 165, are disposed on an electrostatic sensor 110. The spacer 165 is disposed between the two voltage sensors 130A and 130B in plan view. Further, one voltage sensor 130A is disposed straddling one edge 141 of a glass plate 140 in the X direction, and the other voltage sensor 130B is disposed straddling another edge 142 of the glass plate 140.

Four suspension members 151, 152, 153, and 154 are attached to the four corners of a bottom face 110a of the electrostatic sensor 110, in the same way as in the input device 100 illustrated in FIG. 1, and a vibrating element 160 is provided at the middle of the bottom face 110a. The electrostatic sensor 110, glass plate 140, suspension members 151, 152, 153, and 154, and the vibrating element 160, are the same as the electrostatic sensor 10, glass plate 40, suspension members 51, 52, 53, and 54, and vibrating element 60 in the above-described embodiment. The voltage sensors 130A and 130B differ from the piezoelectric sensor 30 in the embodiment described above with regard to planar shape, but are configured the same other than planar shape.

The spacer 165 is formed of a non-electroconductive synthetic resin, for example, and is formed thinner than the voltage sensors 130A and 130B. Accordingly, in a state where no external force is being applied to the glass plate 140, a gap is maintained between the spacer 165 and the glass plate 140, while in a case where external force of a predetermined magnitude is applied to the glass plate 140, the spacer 165 and the bottom face of the glass plate 140 come into contact.

When pressing force is applied to the input device 200, as external force from the upper side in the Z-axial direction, a range of the voltage sensors 130A and 130B corresponding to the glass plate 140 is pressured. Now, the amount of deformation of the voltage sensors 130A and 130B supported by adhesive agent is greater than the amount of contraction of the suspension members 151 through 154 due to difference in elasticity, so shearing force is applied in the direction of pressing (vertical direction) at the voltage sensors 130A and 130B, and the voltage sensors 130A and 130B contract downwards at a range corresponding to the glass plate 140. Thus, two voltage sensors 130A and 130B are used, and disposed to straddle the edge faces of the glass plate 140, so the pressing force on the glass plate 140 is concentrated as shearing force, and accordingly detection sensitivity can be improved.

Although the present invention has been described by way of the above-described embodiment, the present invention is not restricted to the above-described embodiment, and improvements or modifications may be made within the object of improvement and the scope of the spirit of the present invention.

The input device according to the present invention is useful in that it can reduce the load on the user when changing the display form of a display object and when returning the changed display form to the original form, and a desired display form can be accurately obtained.

What is claimed is:

1. An input device, comprising:
an operating surface at which touch operations relating to changing a display form of a display object are performed;
a contact sensor configured to detect touch operations as to the operating surface;
a pressure sensor configured to detect pressing operations as to the operating surface;
a tactile feedback presentation element configured to present tactile feedback corresponding to operations detected by the touch sensor; and
a tactile feedback controller configured to control the tactile feedback presented by the tactile feedback presentation element,
wherein, in a case where an operation detected by the touch sensor is a specified operation specified beforehand out of the contact operations relating to changing the display form, the tactile feedback controller causes the tactile feedback presentation element to present tactile feedback corresponding to that specified operation.

2. The input device according to claim 1,
wherein the operations relating to changing the display form include operations relating to enlarging and reducing the display object, and the specified operation is an operation to enlarge or reduce the display object by a specified scale.

3. The input device according to claim 1,
wherein the operations relating to changing the display form include operations relating to rotating the display object, and the specified operation is an operation to rotate the display object by a specified angle.

4. The input device according to claim 2,
wherein, when the display object returns to the original display form, the tactile feedback controller causes the tactile feedback presentation element to present tactile feedback corresponding thereto.

5. The input device according to claim 1,
wherein resolution for detecting the specified operation is changed between a case where pressure detected by the pressure sensor when the specified operation is performed is a predetermined value or above, and a case where the pressure is smaller than the predetermined value.

6. The input device according to claim 5,
wherein frequency of presenting the tactile feedback is changed in accordance with the pressure in a case where pressure detected by the pressure sensor when the specified operation is performed is the predetermined value or above.
